(19) United States
(12) Patent Application Publication
(10) Pub. No.: US 2016/0345059 A1
(43) Pub. Date: Nov. 24, 2016

(54) METHOD AND DEVICE FOR SWITCHING CHANNEL

(71) Applicant: Lemobile Information Technology (Beijing) Co., Ltd, Beijing (CN)

(72) Inventors: Xizhe XIAO, Beijing (CN); Xiaobin WANG, Beijing (CN); Shixing LI, Beijing (CN); Peng GAI, Beijing (CN); Fei WANG, Beijing (CN); Bo LI, Beijing (CN)

(21) Appl. No.: 15/159,610

(22) Filed: May 19, 2016

(30) Foreign Application Priority Data
May 19, 2015 (CN) 201510257938.6

(51) Int. Cl. H04N 21/443; H04N 21/422; H04N 21/482; H04N 21/431; G06F 3/0488; H04N 21/472

(52) U.S. Cl. CPC H04N 21/4438; G06F 3/04883; H04N 21/47202; H04N 21/4821; H04N 21/4316; H04N 21/42224

(57) ABSTRACT

The embodiments of the disclosure provide a method and device for switching channel. Method includes: when a first touch gesture for a first channel is detected, loading at least one channel display window after an enlargement processing; displaying channel information of the first channel on the channel display window of a display interface; when a second touch gesture is detected, moving the channel information displayed on channel display windows based on a direction of the second touch gesture; and when the channel information of the second channel is displayed on the channel display window of the display interface, playing back video data of the second channel. In the embodiments of the disclosure, the displaying of channel information informs user of the channel which can be triggered by the touch gesture, and the switching of channel information informs user of the timing of channel switch.

### CROSS-REFERENCE TO RELATED APPLICATIONS

The present disclosure is based upon and claims priority to Chinese Patent Application No. CN201510257938.6 filed May 19, 2015, the entire contents of all of which are incorporated herein by reference.

### FIELD OF TECHNOLOGY

The disclosure relates to the field of video processing technologies, and particularly to a method for switching channel and a device for switching channel.

### BACKGROUND

With rapid development of internet, an internet video application can be used not only to watch live programs, but also to search a great number of network resources for a desirable program genre of a user through internet functions. Therefore, the internet video application has been widely used in people's life.

In a video application, most of interactions of a user interface (UI) are based upon a touch-screen mode, including channel switch.

Currently, the way of gesture channel-switching is to add a gesture recognition function to a UI Control. In other words, a judgment for a gesture in a specific direction is added to a specific region of the UI Control, and upon the judgment the channel-switching may be triggered. During the switching, the channel is directly switched by the video application, which may easily result in an incorrect manipulation, such as incorrect switching. In the case of the incorrect manipulation, the user will necessarily switch once more, resulting in the waste of resources for an electronic terminal.

### SUMMARY

In the view of above problems, the embodiments of the disclosure are proposed to provide a method for switching channel and a corresponding device for switching channel, for overcoming or at least partially solving above problems.

To address above problems, the embodiment of the disclosure provides a method for switching channel, including:
when a first touch gesture for a first channel is detected, loading at least one channel display window after an enlargement processing;
displaying channel information of the first channel on the channel display window of a display interface;
when a second touch gesture is detected, moving the channel information displayed on channel display windows based on a direction of the second touch gesture; and
when the channel information of the second channel is displayed on the channel display window of the display interface, playing back video data of the second channel.

The embodiment of the disclosure also provides a device for switching channel, including:
a channel display window loading module, configured to, when a first touch gesture for a first channel is detected, load at least one channel display window after an enlargement processing;
a first channel information displaying module, configured to display channel information of the first channel on the channel display window of a display interface;
a first channel information moving module, configured to, when a second touch gesture is detected, move the channel information displayed on channel display windows based on a direction of the second touch gesture; and
a second channel playback module, configured to, when the channel information of the second channel is displayed on the channel display window of the display interface, play back video data of the second channel.

The embodiment of the disclosure also provides an electronic terminal for switching channel, characterized in that the electronic terminal includes:
at least one processor;
a memory for storing at least one instruction executable by the processor;
wherein the processor is configured to perform:
when a first touch gesture for a first channel is detected, loading at least one channel display window after an enlargement processing;
displaying channel information of the first channel on the channel display window of a display interface;
when a second touch gesture is detected, moving the channel information displayed on channel display windows based on a direction of the second touch gesture; and
when the channel information of the second channel is displayed on the channel display window of the display interface, playing back video data of the second channel.

The embodiments of the disclosure may have following advantages:

According to the embodiments of the disclosure, in channel switch, the channel information of channels is moved on the channel display windows after the enlargement processing. If the channel display window of the display interface displays the channel information of the second channel, then the second channel may be played back. The displaying of channel information may inform the user of the channel which can be triggered by the touch gesture, and the switching of channel information may inform the user of the timing of channel switch. Therefore, possibility of incorrect manipulation can be greatly reduced, then more switches are avoided and the waste of resources for an electronic terminal is lowered.

### BRIEF DESCRIPTION OF THE DRAWINGS

FIG. 1 is a flow chart of a method for switching channel according to a first embodiment of the disclosure;

FIG. 2A and FIG. 2B are schematic diagrams of an enlargement processing according to the embodiment of the disclosure;

FIG. 3 is a schematic diagram illustrating movement of channel information after the enlargement processing according to the embodiment of the disclosure;

FIG. 4 is a flow chart of a method for switching channel according to a second embodiment of the disclosure;

FIG. 5A to FIG. 5E are schematic diagrams illustrating movement of channel information before the enlargement processing according to the embodiment of the disclosure; and

FIG. 6 is a block diagram of a device for switching channel according to an embodiment of the disclosure.

### DESCRIPTION OF THE EMBODIMENTS

In order to more clearly understand above objects, features and advantages of the disclosure, hereinafter the disclosure will be further described in detail in conjunction with accompanying drawings and specific implementations.

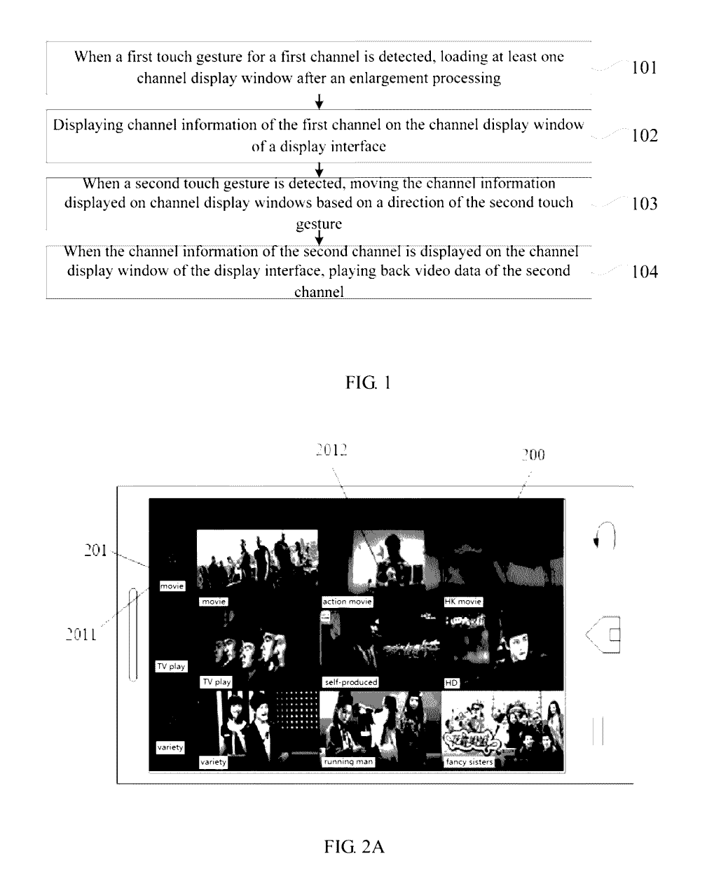

With reference to FIG. 1, it shows a flow chart of a method for switching channel according to a first embodiment of the disclosure. The method may particularly include steps of:

Step 101, when a first touch gesture for a first channel is detected, loading at least one channel display window after an enlargement processing.

Step 102, displaying channel information of the first channel on the channel display window of a display interface.

It should be explained that, the embodiment of the disclosure can be applicable to electronic terminals, such as mobile phone, tablet, smart watch, etc., which should not restricted by the embodiment of the disclosure.

The electronic terminal may include an operating system such as Android, IOS or WindowsPhone, which may support an operation of the video application, such that the video application may support a live channel function, for example.

Before the enlargement processing, the display interface of the electronic terminal may include at least one category channel display region which can be used to display information of a channel category.

Further, the category channel display region may include a first display sub-region and at least a second display sub-region. The first display sub-region may be used to display a channel category identifier, the second display sub-region may be used to display the channel display window, the channel display window may be used to display channel information corresponding to a channel in the channel category (i.e., information in relation to the channel), and the channel information may contain information such as channel images and channel texts.

In a specific implementation, a user may trigger a loading of first channel display window by the first touch gesture such as single-click, double-click and the like, to display the channel information of the first channel.

It should be explained that the first channel is a channel to which video data being played pertains. Herein, the channel display window may include an image floating layer and/or a text floating layer.

The image floating layer may be used to load image information. In the embodiment of the disclosure, the image floating layer may be used to display a channel images which could be image data reflecting a feature of this channel, such as image data which contains LOGO of a satellite channel and which can be used to identify the channel.

The text floating layer may be used to load text information. In the embodiment of the disclosure, the text floating layer may be used to display channel texts which could be text data reflecting a feature of this channel, such as a channel name. The channel texts may contain program contents, such as program name and broadcast time of program.

In Android system, the image floating layer may be a custom class inherited from an ImageView class, and the text floating layer may be a custom class inherited from a TextView class.

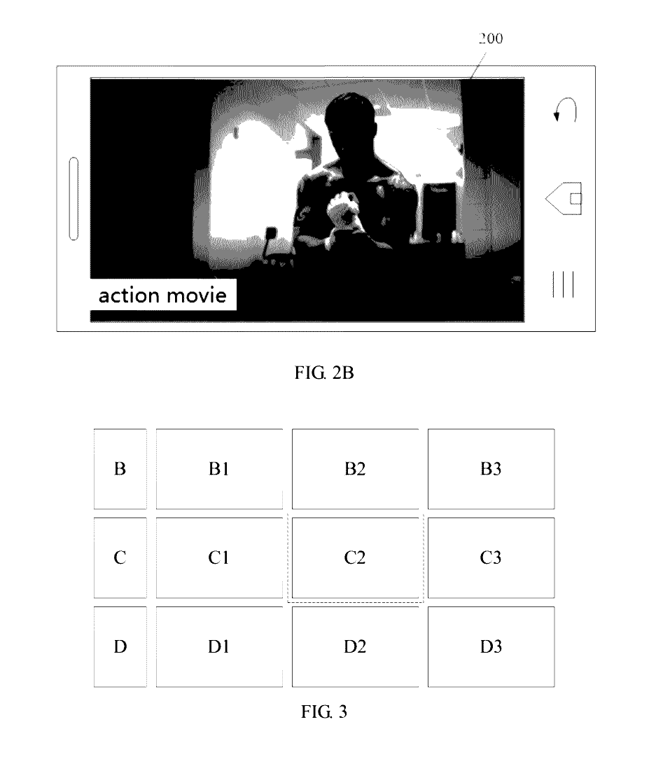

For example, as shown in FIG. 2A, the display interface 200 of the electronic terminal may include three category channel display regions, such as category channel display region 201 which is used to display information in a movie channel category. In the first display sub-region 2011 of the category channel display region 201, the channel category identifier “movie” and its LOGO (icon) of the movie channel category is displayed. Further, the category channel display region 201 may include three second display sub-regions, such as second display sub-region 2012. The channel display window in the second display sub-region 2012 may display the channel information corresponding to an action movie channel.

The enlargement processing may indicate that at least one channel display window and loaded channel information thereof are enlarged in accordance with a size of display region, such that the channel display window to which the first channel being played pertains could fill the whole display region. Channel display windows to which other channels pertain are out of the display region, and that is, invisible to the user.

For example, as shown in FIG. 2B, if the first channel being played is an “action movie” channel, then when the user triggers the first touch gesture, a channel display window to which the “action movie” channel pertains may be loaded to display channel information of the “action movie” channel.

Step 103, when a second touch gesture is detected, moving the channel information displayed on channel display windows based on a direction of the second touch gesture.

In the embodiment of the disclosure, the user may trigger the channel switch by the second touch gesture.

In a specific implementation, the channel display windows may be arranged in a first direction, such as transverse arrangement, longitudinal arrangement or oblique arrangement, which should not restricted by the embodiment of the disclosure.

Taking the transverse arrangement as an example, as shown in FIG. 3, it is assumed that there are three channel categories which are B, C and D, respectively and each of channel categories has three channels which are arranged in a transverse direction. The channels in the channel category B may include B1, B2 and B3; the channels in the channel category C may include C1, C2 and C3; and the channels in the channel category D may include D1, D2 and D3. Currently, the channel C2 in the channel category C is displayed on the display interface (a portion indicated by dotted line) of the electronic terminal.

In a preferred embodiment of the disclosure, Step 103 may include sub-steps of:

Sub-step S11, judging a direction of the second touch gesture.

In a specific implementation, a touch event for calculating the second touch gesture may judge the direction. The touch event may include a down event (Down), a move event (Move), an up event (Up), etc.

In an example, the down event (Down) may be preferentially selected to calculate a sliding direction. If the up event (Up) is detected, then the up event (Up) may be preferentially selected to cooperatively calculate the sliding direction with the down event (Down). If the up event (Up) is detected, then a recently occurred move event (Move) may be used to cooperatively calculate the sliding direction with the down event (Down).

The direction of the second touch gesture may refer to a sliding direction, which is pointed to a direction from a position of a prior occurred touch event towards a position of a later occurred touch event.

For example, on the condition that the down event (Down) occurs at a position a (x1, y1) at time t1, the up event (Up) occurs at a position b (x2, y2) at time t2, and t1 is earlier than t2, then the direction may pointing to b from a, namely a a→b.

Sub-step S12, if the direction of the second touch gesture is judged to be a first direction, moving the channel information of the channel display windows in the first direction, so as to display, in the channel display windows of the display interface, channel information of a second channel which pertains to the same channel module list as the first channel and which is positioned adjacently to the first channel.

In the embodiment of the disclosure, it is possible to switch adjacent channels in the same channel category.

In particular, the first position of the first channel may be located in the channel module list (ChannelModule) to which the first channel pertains, a position which is adjacent to the first position and which is located in the channel module list according to the direction of the second touch gesture is a second position, and a channel at the second position may be determined to be the second channel.

The second position may be on the left side of the first position (for example, a previous channel), or on the right side of the first position (for example, a next channel).

Herein, the channel module list (ChannelModule) is abstractive data structure for channels, including a channel list of all the channels under a certain channel category. The channel list may particularly include data such as channel IDs, channel names, stream address, channel images and positional order among channels.

Since the size of the channel module list (ChannelModule) is very large, generally, a server may be requested for partial data of the channel module list (ChannelModule). If there is no necessary data at local host, then the server may be requested again.

Of course, it is also possible to request for all the data of the channel module list (ChannelModule). This should not be restricted by the embodiment of the disclosure.

The channel module list (ChannelModule) may be obtained from the server when the channel information of channel categories is loaded initially. The channel module list (ChannelModule) usually is a Json (JavaScript Object Notation) format. Then relative information may be obtained after being parsed.

Further, in the channel module list, the data in relation to the first channel may be obtained by the first position (index).

Herein, the index is equivalent to a subscript of an array. A corresponding item in the array (i.e., channel module list) may be located by the subscript.

For example, as shown in FIG. 3, the first channel displayed in full screen in the display region (dotted box) is a channel C2. Channel information of channel C1 and channel C3 and channel information of channel C2 are subjected to the same enlargement processing. If the direction of the second touch gesture is from left to right, then the second position may be a position on the left side of the first position, i.e., C1, and then the channel information of C1 may be displayed in the display region (dotted box). If the direction of the second touch gesture is from right to left, then the second position may be a position on the right side of the first position, i.e., C3, and then the channel information of C3 may be displayed in the display region (dotted box).

Sub-step S13, if the direction of the second touch gesture is judged to be a second direction, moving the channel information of the channel display windows in the second direction, so as to display, in the channel display windows of the display interface, channel information of a second channel which pertains to an adjacent channel module list and which is at the same position as the first channel, wherein the second direction is perpendicular to the first direction.

In the embodiment of the disclosure, it is also possible to switch adjacent channels in different channel categories.

In particular, the first position of the first channel may be located in the channel module list (ChannelModule) to which the first channel pertains, an adjacent channel module list is determined according to the direction of the second touch gesture, a position which is the same as the first position and which is located in the channel module list is a second position, and a channel at the second position may be determined to be the second channel.

The second position may be above the first position, or below the first position.

For example, as shown in FIG. 3, the first channel displayed in full screen in the display region (dotted box) is a channel C2. Channel information of channel B2 and channel D2 and channel information of channel C2 are subjected to the same enlargement processing. If the direction of the second touch gesture is from up to down, then the second position may be a position above the first position, i.e., B2, and then the channel information of B2 may be displayed in the display region (dotted box). If the direction of the second touch gesture is from down to up, then the second position may be a position below the first position, i.e., D2, and then the channel information of D2 may be displayed in the display region (dotted box).

It should be explained that it is possible to extract the channel information of the second channel from local cache. If fail to extract, then the server may be requested for the channel information of the second channel.

Step 104, when the channel information of the second channel is displayed on the channel display window of the display interface, playing back video data of the second channel.

If the channel information of the second channel is displayed in the channel display window of the display interface, it may indicate the switching to the second channel.

In a preferred embodiment of the disclosure, Step 104 may include sub-steps of:

Sub-step S21, searching for stream address of the second channel;

Sub-step S22, sending the stream address of the second channel to a player and loading it; and

Sub-step S23, when the stream address of the second channel is completely loaded by the player, removing the channel display window.

The player may be used to load the video data. In the embodiment of the disclosure, the player may load the first channel and the second channel.

In Android system, the player may be a custom class inherited from a VeidoView class.

After the position of the second channel is located, then the channel module list (ChannelModule) is searched for the corresponding stream address. The player may load the stream address for example on the basis of M3U8 standard, and request for the video data of the second channel to play back.

Every operation of switching the channel may result in the switch between different code streams. In the current manner of switching channel, a black screen may appear for a while prior to playback, which results in an inferior experience.

Therefore, in the embodiment of the disclosure, while the stream address is loaded by the player, relevant channel information may be loaded in the channel display window. For example, while the channel texts are loaded in the text floating layer, the channel images may be loaded in the image floating layer.

When the player completely loads the stream address and begins playing back the video, the channel display window may be removed to gradually fade out the channel information such as channel texts and channel images, followed by playing back a program of a second video without the black screen.

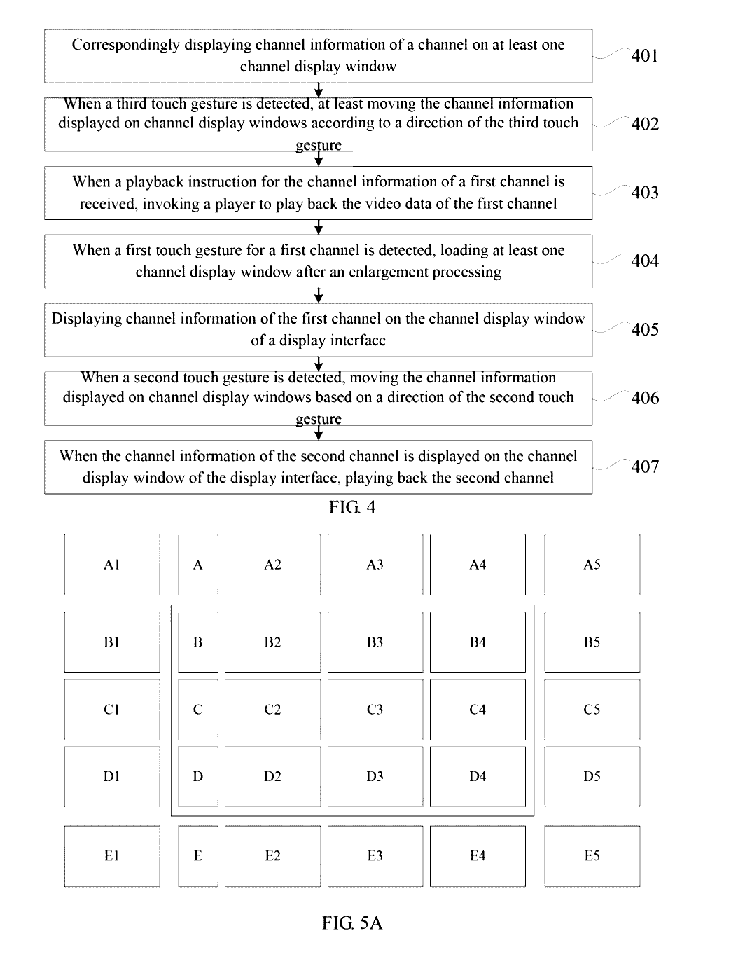

With reference to FIG. 4, it shows is a flow chart of a method for switching channel according to a fourth embodiment of the disclosure. The method may particularly include steps of:

Step 401, correspondingly displaying channel information of a channel on at least one channel display window.

In a specific implementation, if a user clicks to enter a live-broadcasting page of a video application, the video application may request a server for a channel module list (ChannelModule) of the at least one channel category, and select to display at least one piece of channel information from the channel module list (ChannelModule).

Step 402, when a third touch gesture is detected, at least moving the channel information displayed on channel display windows according to a direction of the third touch gesture.

In the embodiment of the disclosure, according to the direction of the third touch gesture, channel information of a portion of channels may be moved from the current channel display window to an adjacent channel display window, channel information of a portion of channels may be moved out of the channel display window, and channel information of new channel may be displayed in a blank channel display window after the movement of the channel information.

When the channel information of channel display windows is moved, the channel texts may be moved in the text floating layer in the same manner and the channel images may be moved in the image floating layer to be kept over a certain channel image, displaying the channel information of the same channel.

In a specific implementation, the second display sub-regions may be arranged in the first direction, such as transverse arrangement, longitudinal arrangement, or oblique arrangement. This should not be restricted by the embodiment of the disclosure.

In a preferred embodiment of the disclosure, Step 402 may include sub-steps of:

Sub-step S31, when the third touch gesture is detected in the second display sub-region, judging a direction of the third touch gesture.

In the embodiment of the disclosure, the user may input the third touch gesture in the second display sub-region to trigger the switching of the channel information.

Sub-step S32, if the direction of the third touch gesture is judged to be the first direction, moving the channel information of channel display windows in the first direction.

When the direction of the third touch gesture is equal to the arrangement direction of the second display sub-region, then it is possible to fix a channel category identifier of the first display sub-region, to remove the channel information at the boundary in the first direction, to move the remaining channel information by a position of one channel display window in the first direction and display, and to move new channel information into a formed blank channel display window.

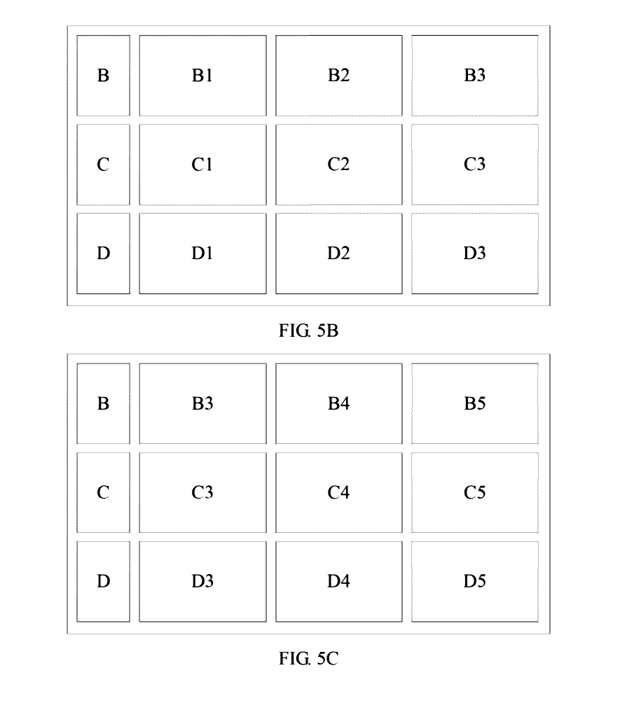

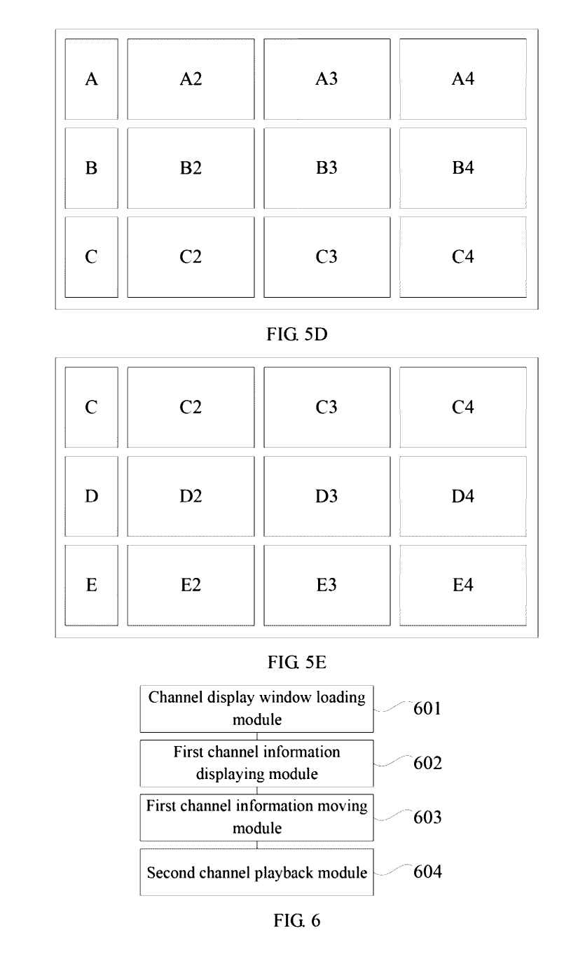

For example, as shown in FIG. 5A, it is assumed that there are five channel categories which are A, B, C, D and E, respectively and each of channel categories has five channels, wherein channels in the channel category A may include A1, A2, A3, A4 and A5; channels in the channel category B may include B1, B2, B3, B4 and B5; channels in the channel category may include C1, C2, C3, C4 and C5; channels in the channel category D may include D1, D2, D3, D4 and D5; and channels in the channel category E may include E1, E2, E3, E4 and E5. Currently, channels B2, B3 and B4 in the channel category B, channels C2, C3 and C4 in the channel category C, channels D2, D3 and D4 in the channel category D are displayed in the display interface of the electronic terminal.

If the direction of the third touch gesture is from the left side to the right side (first direction), as shown in FIG. 3B, it is possible to fix the channel category identifiers of the channel categories B, C and D, to remove the channel information of channels B4, C4 and D4 at the boundary from the left side to the right side (first direction), to move the channel information of the remaining channels B2, B3, C2, C3, D2 and D3 by a position of one channel display window from the left side to the right side (first direction) and display, and to move new channel information of channels B1, C1 and D1 into formed blank channel display windows.

If the direction of the third touch gesture is from the right side to the left side (first direction), as shown in FIG. 3C, it is possible to fix the channel category identifiers of the channel categories B, C and D, to remove the channel information of channels B1, C1 and D1 at the boundary from the right side to the left side (first direction), to move the channel information of channels B2, B3, C2, C3, D2 and D3 by a position of one channel display window from the right side to the left side (first direction) and display, and to move new channel information of channels B5, C5 and D5 into formed blank channel display windows.

Sub-step S33, if the direction of the third touch gesture is judged to be the second direction, moving a channel category identifier and channel information of channel display windows in the second direction, wherein the second direction is perpendicular to the first direction.

When the direction of the third touch gesture is perpendicular to arrangement direction of the second display sub-region, then it is possible to remove the channel category identifiers and the channel information at the boundary in the second direction, to move the remaining channel category identifiers and channel information by a position of one first display sub-region and channel display window in the first direction and display, and to move new channel category identifier and channel information into a formed blank first display sub-region and channel display window.

If the direction of the third touch gesture is from up to down (second direction), as shown in FIG. 5D, it is possible to remove the category identifier and the channel information of the channel category D at the boundary from up to down (second direction), to move the channel information of the channel categories B and C by a position of one first display sub-region and channel display window from up to down (second direction) and display, and to move new channel category identifier and channel information of channel A into a formed blank first display sub-region and channel display window.

If the direction of the third touch gesture is from down to up (second direction), as shown in FIG. 5E, it is possible to remove the category identifier and the channel information of channel category A at the boundary from down to up (second direction), to move the channel information of channel categories C and D by a position of one first display sub-region and channel display window from down to up (second direction) and display, and to move new channel category identifier and channel information of channel E into a formed blank first display sub-region and channel display window.

In another preferred embodiment of the disclosure, Step 402 may include sub-steps of:

Sub-step S34, when the direction of the third touch gesture is detected in the first display sub-region to be the second direction, moving the channel category identifier and channel information displayed on the channel display windows in the second direction, wherein the second direction is perpendicular to the first direction.

In the embodiment of the disclosure, the user may input the second touch gesture in the first display sub-region to trigger the switching of the channel information.

When the direction of the third touch gesture is perpendicular to arrangement direction of the second display sub-region, then it is possible to remove the channel category identifier and the channel information at the boundary in the second direction, to move the remaining channel category identifier and channel information by a position of one first display sub-region and channel display window in the first direction and display, and to move new channel category identifier and channel information into a formed blank first display sub-region, channel display window.

In current selection of channels, after selecting a certain channel category at an up-level page, the user may view a channel with a jump to a down-level page of the channel category. If the user needs to view a channel of other channel category, then he/she is request to return to the up-level page and then jump to a down-level page of the channel category to view. In the process of selecting channels by the user, the switching between up and down level pages is very frequent and the operation thereof is complicated.

In the embodiment of the disclosure, different category channel display regions are displayed in the display interface, so as to display channels of different channel categories. The user may switch the channels of different channel categories by a touch gesture in one display interface without switching between up and down level pages, thereby greatly improving simplicity of operation.

Step 403, when a playback instruction for the channel information of a first channel is received, invoking a player to play back the video data of the first channel.

If the channel information displayed in the current channel display window contains the channel information of the first channel, the user may trigger the playback instruction of the first channel by clicking the channel information of first channel or clicking a playback control.

In a preferred embodiment of the disclosure, Step 403 may include sub-steps of:

Sub-step S41, loading at least one channel display window.

In the embodiment of the disclosure, the channel display window can be loaded according to information such as a custom size and position.

For example, a text floating layer may be loaded according to corresponding information such as a custom size and position, and an image floating layer may be loaded according to corresponding information such as a custom size and position.

Sub-step S42, performing the enlargement processing on the channel display window, so as to display the channel display window corresponding to the first channel on the display interface.

In a specific implementation, the enlargement processing may be performed on the channel category identifier and channel display window in its entirety, such that the channel display window corresponding to the first channel is displayed in the display interface while the channel category identifier and other channel display windows are kept invisible.

Sub-step S43, sending stream address of the first channel to the player and loading it.

In a specific implementation, through the first channel, it is possible to search the first position (index) of the channel module list and the channel module list (ChannelModule) of the channel category to which the first channel pertains for relevant information, including the stream address.

The player may load the stream address on the basis of M3U8 standard, and request for the video data of the second channel to play back.

Sub-step S44, when the stream address of the first channel is being loaded by the player, displaying the channel information of the first channel on the channel display window of the display interface.

Sub-step S45, when the stream address of the first channel is completely loaded the player, removing the channel display window.

After obtaining the stream address, the player may load the stream address on the basis of M3U8 standard and request for the video data of the first channel to play back.

The player may be invoked to load code stream when the channel is initially played. In the current manners of loading channel, a black screen may appear for a while prior to playback, which results in an inferior experience.

Therefore, in the embodiment of the disclosure, while the player is invoked to load the stream address, relevant channel information may be loaded in the channel display window. For example, while the channel texts are loaded in the text floating layer, the channel images may be loaded in the image floating layer.

When the player completely loads the stream address and begins playing back the video, the channel display window may be removed to gradually fade out the channel information such as channel texts and channel images, followed by playing back a program of the first channel without the black screen.

In the meanwhile, since the channel information of the first channel displayed in the display interface is the same as the channel information of first channel the displayed when loading the stream address, a smooth transition of the switching operation of the player may be improved.

Since an enlarged channel display window is used when switching the channel, which means to display still in the same channel display window, then the embodiment of the disclosure may switch one channel category or the different channel categories based on the same channel display window, thereby realizing the channel switching in another page.

Step 404, when a first touch gesture for a first channel is detected, loading at least one channel display window after an enlargement processing.

Step 405, displaying channel information of the first channel on the channel display window of a display interface.

Step 406, when a second touch gesture is detected, moving the channel information displayed on channel display windows based on a direction of the second touch gesture.

Step 407, when the channel information of the second channel is displayed on the channel display window of the display interface, playing back the second channel.

It should be explained that the method embodiments as described above, for the purpose of brief description, are described as a series of combined actions. However, it should be appreciated by those skilled in the art that the embodiments of the disclosure should not be restricted by the sequence of the actions as set forth, since some of actions could be performed in different sequence or simultaneously according to the embodiments of the disclosure. Moreover, it should also be appreciated by those skilled in the art that, the embodiments as described in the specification are preferred embodiments and actions concerned are not necessarily required in the embodiments of the disclosure.

With reference to FIG. 6, it shows is a block diagram of a device for switching channel according to an embodiment of the disclosure. The device may particularly include following modules:

a channel display window loading module 601, configured to, when a first touch gesture for a first channel is detected, load at least one channel display window after an enlargement processing;

a first channel information displaying module 602, configured to display channel information of the first channel on the channel display window of a display interface;

a first channel information moving module 603, configured to, when a second touch gesture is detected, move the channel information displayed on channel display windows based on a direction of the second touch gesture; and

a second channel playback module 604, configured to, when the channel information of the second channel is displayed on the channel display window of the display interface, play back the second channel.

In a preferred embodiment of the disclosure, the channel display windows are arranged in the first direction, and the first channel information moving module 603 may include following sub-module:

a first direction judging sub-module, configured to judge a direction of the second touch gesture;

a first movement sub-module, configured to, if the direction of the second touch gesture is judged to be a first direction, move the channel information of the channel display windows in the first direction, so as to display, in the channel display windows of the display interface, channel information of a second channel which pertains to the same channel module list as the first channel and which is positioned adjacently to the first channel; and

a second movement sub-module, configured to, if the direction of the second touch gesture is judged to be a second direction, move the channel information of the channel display windows in the second direction, so as to display, in the channel display windows of the display interface, channel information of a second channel which pertains to an adjacent channel module list and which is at the same position as the first channel, wherein the second direction is perpendicular to the first direction.

In a preferred embodiment of the disclosure, the second channel playback module 604 may include following sub-module:

a stream address searching sub-module, configured to search for stream address of the second channel;

a first stream address sending sub-module, configured to send the stream address of the second channel to a player and load it; and

a first channel display window removing sub-module, configured to, when the stream address of the second channel is completely loaded by the player, remove the channel display window.

In a specific implementation, prior to the enlargement processing, the display interface of the current electronic terminal may contain at least one category channel display region, the category channel display region may include a first display sub-region and at least one second display sub-region, the first display sub-region may be used to display a channel category identifier, the second display sub-region may be used to display the channel display window, and the channel display window may be used to display the channel information corresponding to the channel of the channel category.

In a preferred embodiment of the disclosure, the device may include following modules:

a second channel information displaying module, configured to correspondingly display channel information of the channel in at least one channel display window, wherein the channel includes the first channel; and

a first channel playback module, configured to, when a playback instruction for the channel information of a first channel is received, invoke a player to play back the video data of the first channel.

In a preferred embodiment of the disclosure, the first channel playback module may include following sub-modules:

a window loading sub-module, configured to load at least one channel display window;

an enlargement processing sub-module, configured to perform the enlargement processing on the channel display window, so as to display the channel display window corresponding to the first channel on the display interface;

a second stream address sending sub-module, configured to send stream address of the first channel to the player and load it;

a window displaying sub-module, configured to when the stream address of the first channel is being loaded by the player, display the channel information of the first channel on the channel display window of the display interface; and

a second channel display window removing sub-module, configured to when the stream address of the first channel is completely loaded the player, remove the channel display window.

In a preferred embodiment of the disclosure, the device may further include following modules:

a second channel information moving module, configured to, when a third touch gesture is detected, at least move the channel information displayed on channel display windows according to a direction of the third touch gesture.

In a preferred embodiment of the disclosure, the second display sub-region may be arranged in the first direction, and the second channel information moving module may include following sub-modules:

a second direction judging sub-module, configured to, when the third touch gesture is detected in the second display sub-region, judge a direction of the third touch gesture;

a third movement sub-module, configured to, if the direction of the third touch gesture is judged to be the first direction, move the channel information of channel display windows in the first direction; and

a fourth movement sub-module, configured to, if the direction of the third touch gesture is judged to be the second direction, move a channel category identifier and channel information of channel display windows in the second direction, wherein the second direction is perpendicular to the first direction.

In a preferred embodiment of the disclosure, the second display sub-regions are arranged in the first direction, the second channel information moving module may include following sub-modules:

a fifth movement sub-module, configured to, when the direction of the third touch gesture is detected in the first display sub-region to be the second direction, move the channel category identifier and channel information displayed on the channel display windows in the second direction, wherein the second direction is perpendicular to the first direction.

In a specific implementation, the channel display window may include an image floating layer and/or a text floating layer, and the channel information may contain channel image information and/or image text information.

The image floating layer may be used to load the channel image information, and the text floating layer may be used to load the channel text information.

Since the device embodiments are substantially similar to the method embodiments, the description thereof is relatively brief. As for the related parts thereof, reference may be made to the relevant description of the method embodiment

The various embodiments in the specification have been explained step by step.

Each of the embodiments has only emphasized the differences from others, and the same or similar parts between embodiments could be referred to each other.

It should be understood by those skilled in the art, embodiments of in the disclosure could be provided as a method, a device and a computer program product. Therefore, the embodiments of the disclosure may employ the forms of complete hardware embodiment, complete software embodiment or combination of hardware and software. Further, the embodiments of in the disclosure may employ the form of computer program product realizable on one or more of computer available recording medium (including but not limited to magnetic disk storage medium, CD-ROM and optical storage medium, for example) containing computer available program codes.

The embodiments of in the disclosure have been described with reference to flow chart and/or block diagram of method, terminal device (system) and computer program product according thereto. It should be understood that each of steps and/or modules in flow chats and/or block diagrams, and combination of steps and/or modules in flow chats and/or block diagrams could be realized by computer program instructions. The computer program instructions may be provided for a universal computer, a dedicated computer, an embedded processor or a processor of other programmable data processing terminal device to generate a machine, such that the instructions executed by the computer or the processor of other programmable data processing terminal device may form devices for realizing functions specified by one or more steps in the flow charts and/or one or more modules in the block diagrams.

The computer program instructions may also be stored in computer readable memory capable of booting the computer or other programmable data processing terminal device to run in a designated mode, such that the instructions stored in the computer readable memory may form a manufactured product containing instruction device. The instruction device may realize functions specified by one or more steps in the flow charts and/or one or more modules in the block diagrams.

The computer program instructions may also be loaded into the computer or other programmable data processing terminal device, such that the computer or other programmable terminal device may execute a series of operation steps to generate processing realizable by the computer, and in turn the instructions executed on the computer or other programmable terminal device may provide steps for realizing functions specified by one or more steps in the flow charts and/or one or more modules in the block diagrams.

Although preferred embodiments of the disclosure have been described, those skilled in the art may make additional amendments and modifications to the embodiments with substantial creative concept thereof. Therefore, the appended claims are intended to be constructed as encompassing the preferred embodiments and all the amendments and modifications falling into the scope of the embodiments of the disclosure.

In the end, it will be explained that, the terms “first”, “second”, etc. are only used herein to distinguish one element or operation from another element or operation, and does not necessarily require or suggest that there are any actual relationship or sequence between these elements or operations. Further, the terms “comprise”, “include” and any other variants thereof are intended to cover a non-exclusive “comprise”, so that process, method, product or terminal device which includes a series of elements may include not only those elements but also other elements that do not be definitely listed herein, or also may include inherent elements of the process, method, product or terminal device. In the absence of more restrictions, an element defined by the statement “includes a . . . ” is not meant to exclude other same elements in the process, method, product or terminal device including this element.

The method for switching channel and the device for switching channel provided in the disclosure have been described in detail. Herein the principles and implementations of the disclosure are illustrated by way of specific examples. The embodiments described above are only intended to help understand the method and main concept of the disclosure. Meanwhile, for an ordinary person skilled in the art, variations could be made to the specific embodiments and their application scope in accordance with the concept of the disclosure. In summary, the contents of the specification should not be construed as limiting of the disclosure.

What is claimed is:

1. A method for switching channel, characterized in that the method comprises steps of:
when a first touch gesture for a first channel is detected, loading at least one channel display window after an enlargement processing;
displaying channel information of the first channel on the channel display window of a display interface;
when a second touch gesture is detected, moving the channel information displayed on channel display windows based on a direction of the second touch gesture; and
when the channel information of the second channel is displayed on the channel display window of the display interface, playing back video data of the second channel.

2. The method according to claim 1, characterized in that, the channel display windows are arranged in the first direction, and the step of moving the channel information displayed on channel display windows based on a direction of the second touch gesture comprises:
judging a direction of the second touch gesture;
if the direction of the second touch gesture is judged to be a first direction, moving the channel information of the channel display windows in the first direction, so as to display, in the channel display windows of the display interface, channel information of a second channel which pertains to the same channel module list as the first channel and which is positioned adjacently to the first channel; and
if the direction of the second touch gesture is judged to be a second direction, moving the channel information of the channel display windows in the second direction, so as to display, in the channel display windows of the display interface, channel information of a second channel which pertains to an adjacent channel module list and which is at the same position as the first channel, wherein the second direction is perpendicular to the first direction.

3. The method according to claim 1, characterized in that, the step of playing back the second channel comprises:
searching for stream address of the second channel;
sending the stream address of the second channel to a player and loading it; and
when the stream address of the second channel is completely loaded by the player, removing the channel display window.

4. The method according to claim 1, characterized in that, prior to the enlargement processing, the display interface of the current electronic terminal contains at least one category channel display region, the category channel display region comprises a first display sub-region and at least one second display sub-region, the first display sub-region is configured to display a channel category identifier, the second display sub-region is configured to display the channel display window, and the channel display window is configured to display the channel information corresponding to the channel of the channel category.

5. The method according to claim 1, characterized in that, prior to the step of loading at least one channel display window after an enlargement processing, the method further comprises:
correspondingly displaying channel information of a channel on at least one channel display window, wherein the channel includes the first channel; and
when a playback instruction for the channel information of a first channel is received, invoking a player to play back the video data of the first channel.

6. The method according to claim 5, characterized in that, the step of invoking a player to play back the first channel comprises:
loading at least one channel display window;
performing the enlargement processing on the channel display window, so as to display the channel display window corresponding to the first channel on the display interface;
sending stream address of the first channel to the player and loading it;
when the stream address of the first channel is being loaded by the player, displaying the channel information of the first channel on the channel display window of the display interface; and
when the stream address of the first channel is completely loaded the player, removing the channel display window.

7. The method according to claim 5, characterized in that, prior to the step of invoking a player to play back the video data of the first channel, the method further comprises:
when a third touch gesture is detected, at least moving the channel information displayed on channel display windows according to a direction of the third touch gesture.

8. The method according to claim 7, characterized in that, the second display sub-regions are arranged in the first direction, and the step of, when a third touch gesture is detected, at least moving the channel information displayed on channel display windows according to a direction of the third touch gesture, comprises:
when the third touch gesture is detected in the second display sub-region, judging a direction of the third touch gesture;
if the direction of the third touch gesture is judged to be the first direction, moving the channel information of channel display windows in the first direction; and
if the direction of the third touch gesture is judged to be the second direction, moving a channel category identifier and channel information of channel display windows in the second direction, wherein the second direction is perpendicular to the first direction.

9. The method according to claim 7, characterized in that, the second display sub-regions are arranged in the first direction, and the step of, when a third touch gesture is detected, at least moving the channel information displayed on channel display windows according to a direction of the third touch gesture, comprises:
when the direction of the third touch gesture is detected in the first display sub-region to be the second direction, moving the channel category identifier and channel information displayed on the channel display windows in the second direction, wherein the second direction is perpendicular to the first direction.

10. The method according to claim 1, characterized in that, the channel display window comprises an image floating layer or a text floating layer, and the channel information contains channel image information or image text information; and
the image floating layer is configured to load the channel image information, and the text floating layer is configured to load the channel text information.

11. A electronic terminal for switching channel, characterized in that the electronic terminal comprises:
at least one processor;
a memory for storing at least one instruction executable by the processor;
wherein the processor is configured to perform:
when a first touch gesture for a first channel is detected, loading at least one channel display window after an enlargement processing;
displaying channel information of the first channel on the channel display window of a display interface;
when a second touch gesture is detected, moving the channel information displayed on channel display windows based on a direction of the second touch gesture; and
when the channel information of the second channel is displayed on the channel display window of the display interface, playing back video data of the second channel.

12. The electronic terminal according to claim 11, characterized in that, the channel display windows are arranged in the first direction, and the processor is further configured to perform:
judging a direction of the second touch gesture;
if the direction of the second touch gesture is judged to be a first direction, moving the channel information of the channel display windows in the first direction, so as to display, in the channel display windows of the display interface, channel information of a second channel which pertains to the same channel module list as the first channel and which is positioned adjacently to the first channel; and
if the direction of the second touch gesture is judged to be a second direction, moving the channel information of the channel display windows in the second direction, so as to display, in the channel display windows of the display interface, channel information of a second channel which pertains to an adjacent channel module list and which is at the same position as the first channel, wherein the second direction is perpendicular to the first direction.

13. The electronic terminal according to claim 11, characterized in that, the processor is further configured to perform:
searching for stream address of the second channel;
sending the stream address of the second channel to a player and load it; and
when the stream address of the second channel is completely loaded by the player, removing the channel display window.

14. The electronic terminal according to claim 11, characterized in that, prior to the enlargement processing, the display interface of the current electronic terminal contains at least one category channel display region, the category channel display region comprises a first display sub-region and at least one second display sub-region, the first display sub-region is configured to display a channel category identifier, the second display sub-region is configured to display the channel display window, and the channel display window is configured to display the channel information corresponding to the channel of the channel category.

15. The electronic terminal according to claim 11, characterized in that, the processor is further configured to perform:
correspondingly displaying channel information of the channel in at least one channel display window, wherein the channel includes the first channel; and
when a playback instruction for the channel information of a first channel is received, invoking a player to play back the video data of the first channel.

16. The electronic terminal according to claim 15, characterized in that, when a playback instruction for the channel information of a first channel is received, invoking a player to play back the video data of the first channel further comprises:
loading at least one channel display window;
performing the enlargement processing on the channel display window, so as to display the channel display window corresponding to the first channel on the display interface;
sending stream address of the first channel to the player and load it;
when the stream address of the first channel is being loaded by the player, displaying the channel information of the first channel on the channel display window of the display interface; and
when the stream address of the first channel is completely loaded the player, removing the channel display window.

17. The electronic terminal according to claim 15, characterized in that, the processor is further configured to perform:
when a third touch gesture is detected, at least moving the channel information displayed on channel display windows according to a direction of the third touch gesture.

18. The electronic terminal according to claim 17, characterized in that, the second display sub-regions are arranged in the first direction, and when a third touch gesture is detected, at least moving the channel information displayed on channel display windows according to a direction of the third touch gesture further comprises:
when the third touch gesture is detected in the second display sub-region, judging a direction of the third touch gesture;
if the direction of the third touch gesture is judged to be the first direction, moving the channel information of channel display windows in the first direction; and
if the direction of the third touch gesture is judged to be the second direction, moving a channel category identifier and channel information of channel display windows in the second direction, wherein the second direction is perpendicular to the first direction.

19. The electronic terminal according to claim 17, characterized in that, the second display sub-regions are arranged in the f first direction, and when a third touch gesture is detected, at least moving the channel information displayed on channel display windows according to a direction of the third touch gesture further comprises:
when the direction of the third touch gesture is detected in the first display sub-region to be the second direction, moving the channel category identifier and channel information displayed on the channel display windows in the second direction, wherein the second direction is perpendicular to the first direction.

20. The electronic terminal according to claim 11, characterized in that, the channel display window comprises an image floating layer or a text floating layer, and the channel information contains channel image information or image text information; and
the image floating layer is configured to load the channel image information, and the text floating layer is configured to load the channel text information.
